(19) United States
(12) Patent Application Publication
(10) Pub. No.: US 2021/0390407 A1
(43) Pub. Date: Dec. 16, 2021

(54) TRAINING PERSPECTIVE COMPUTER VISION MODELS USING VIEW SYNTHESIS

(71) Applicant: Waymo LLC, Mountain View, CA (US)

(72) Inventors: Vincent Michael Casser, Cambridge, MA (US); Yuning Chai, San Mateo, CA (US); Dragomir Anguelov, San Francisco, CA (US); Hang Zhao, Sunnyvale, CA (US); Henrik Kretzschmar, Mountain View, CA (US); Reza Mahjourian, Austin, TX (US); Anelia Angelova, Sunnyvale, CA (US); Ariel Gordon, North Fork, CA (US); Soeren Pirk, Palo Alto, CA (US)

(21) Appl. No.: 17/344,254

(22) Filed: Jun. 10, 2021

Related U.S. Application Data
(60) Provisional application No. 63/037,492, filed on Jun. 10, 2020.

(51) Int. Cl. G06N 3/08; G06K 9/62; G06K 9/00

(52) U.S. Cl. CPC G06N 3/08; G06K 9/00805; G06K 9/6262; G06K 9/6261

(57) ABSTRACT

Methods, computer systems, and apparatus, including computer programs encoded on computer storage media, for training a perspective computer vision model. The model is configured to receive input data characterizing an input scene in an environment from an input viewpoint and to process the input data in accordance with a set of model parameters to generate an output perspective representation of the scene from the input viewpoint. The system trains the model based on first data characterizing a scene in the environment from a first viewpoint and second data characterizing the scene in the environment from a second, different viewpoint.

### CROSS-REFERENCE TO RELATED APPLICATION

This application claims priority to U.S. Provisional Patent Application No. 63/037,492, filed on Jun. 10, 2020, the disclosure of which is hereby incorporated by reference in its entirety.

### BACKGROUND

This specification relates to training computer vision machine learning models.

Some computer vision models are neural networks.

Neural networks are machine learning models that employ one or more layers of units to predict an output for a received input. Some neural networks include one or more hidden layers in addition to an output layer. The output of each hidden layer is used as an input to or more other layers in the network, i.e., one or more other hidden layers, the output layer, or both. Each layer of the network generates an output from a received input in accordance with current values of a respective set of parameters.

### SUMMARY

This specification describes a system implemented as computer programs on one or more computers in one or more locations that trains a perspective computer vision model, e.g., a neural network. The model is configured to receive input data characterizing an input scene in an environment from an input viewpoint and to process the input data in accordance with a set of parameters (“model parameters”) to generate an output perspective representation of the scene from the input viewpoint. The model can have any appropriate neural network architecture that allows the model to map the input data to the perspective representation. For example, the model can be a convolutional neural network. The data characterizing the scene can be generated, for example, from sensor readings of the scene captured by one or more sensors at the corresponding viewpoint.

For example, the one or more sensors can be sensors of an autonomous vehicle, e.g., a land, air, or sea vehicle, and the scene can be a scene that is in the vicinity of the autonomous vehicle. The perspective representation of the scene can then be used to make autonomous driving decisions for the vehicle, to display information to operators or passengers of the vehicle, or both.

The described system receives first data characterizing a scene in the environment from a first viewpoint and further receives second data characterizing the scene in the environment from a second, different viewpoint. The system processes the first data using the perspective computer vision machine learning model in accordance with current values of the model parameters to generate a first perspective representation of the scene from the first viewpoint, and processes the second data using the perspective computer vision machine learning model in accordance with the current values of the model parameters to generate a second perspective representation of the scene from the second viewpoint. The system further processes a first input including the first perspective representation using a view synthesis system that generates, as output from the first input, a predicted perspective representation of the scene from the second viewpoint. The system can determine a consistency error between the second perspective representation and the predicted perspective representation, and determines, from the consistency error, an update to the current values of the model parameters of the computer vision machine learning model.

In general, the described system can use the perspective computer vision machine learning model to synthesize representations of a scene from various viewpoints in a prediction feature space rather than in an image space. Any perspective representation of a scene, independent of the exact modality, can be used, e.g. semantic segmentation masks, instance segmentation masks, or object detection boxes. The system performs training of the perspective computer vision machine learning model using prediction consistency constraints across multiple viewpoints, e.g., across time and/or space.

The subject matter described in this specification can be implemented in particular implementations so as to realize one or more advantages. By enforcing consistency constraints, the system provides techniques for training of perspective computer vision machine learning models that reach higher accuracy, and produce more temporally consistent predictions, even on unseen data. Further, since the system can formulate the consistency constraints on fully unlabeled data, less annotated data may be needed by the described training techniques to build a model of equivalent performance when consistency losses are used. The consistency losses can also exhibit a regularizing effect that prevents overfitting to limited labeled data, and thus further improving the training accuracy and reducing the need for labeled data.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example machine learning model training system.

FIG. 2 shows an example process of training a perspective computer vision machine learning model.

FIG. 3 is a flow diagram illustrating an example process for training a perspective computer vision machine learning model.

Like reference numbers and designations in the various drawings indicate like elements.

### DETAILED DESCRIPTION

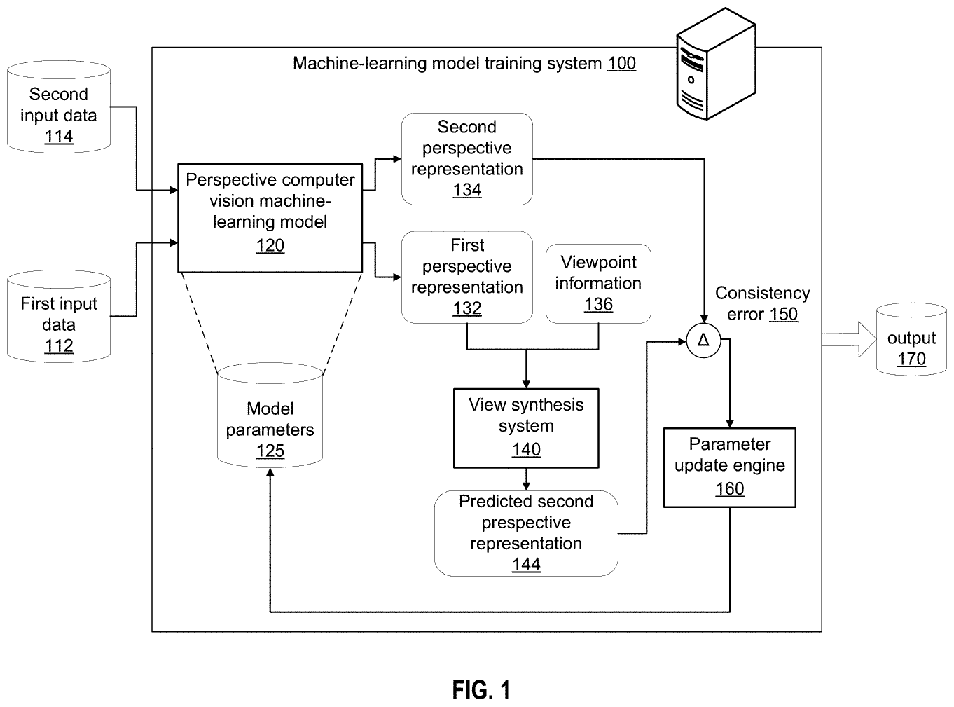

FIG. 1 shows an example of a machine learning model training system 100. The system 100 is an example of a system implemented as computer programs on one or more computers in one or more locations, in which the systems, components, and techniques described below can be implemented.

In general, the system 100 performs training of a perspective computer vision machine learning model 120 using first input data 112 that characterizes a scene in the environment from a first viewpoint and second input data 114 that characterizes the scene in the environment from a second, different viewpoint, and generates output data 170. The output data 170 can include the updated model parameters 125 of the trained perspective computer vision machine learning model 120, and can further include the performance metrics of the training process, such as the training and/or validation losses.

The perspective computer vision machine learning model 120 has a plurality of model parameters 125, and is configured to receive input data characterizing an input scene in an environment from an input viewpoint and to process the input data in accordance with the model parameters to generate an output perspective representation of the scene from the input viewpoint. In this specification, the model 120 is referred to as a “perspective” machine learning model because the model generates perspective representations, i.e., representations of the scene from the perspective of a sensor or agent located at a given viewpoint within the scene.

In some implementations, the perspective computer vision machine learning model 120 can be a neural network having any appropriate neural network architecture that allows the model to map the input data to the perspective representation. For example, the neural network can include a convolutional neural network. The model parameters include network parameters (e.g., the weight and bias coefficients) of the neural network.

The perspective computer vision machine learning model 120 can be any of a variety of computer-vision related prediction models. For example, the perspective computer vision machine learning model can be a semantic segmentation model that outputs a semantic segmentation mask of the input scene at the input viewpoint. In another example, the perspective computer vision machine learning model can be an object detection model that outputs data identifying locations of one or more objects in the input scene at the input viewpoint. In another example, the perspective computer vision machine learning model can be an instance segmentation model that outputs an instance segmentation mask of the input scene at the input viewpoint.

The input data to the perspective computer vision machine learning model 120 characterizes a scene from a viewpoint. The input data (e.g., the first input data 112 or the second input data 114) can be generated, for example, from sensor readings of the scene captured by one or more sensors at the corresponding viewpoint. For example, the one or more sensors can be sensors of an autonomous vehicle or other agent navigating in the environment.

The input data characterizing the scene can include various types of data. In an example, the input data can include an image of the environment captured by an imaging device (e.g., a camera) at an input viewpoint. In another example, the input data can include point cloud data of the environment captured at the input viewpoint. The point cloud data can be generated based on measurements made by a scanning device (e.g., a LiDAR device) at the input viewpoint. The point cloud data can also be synthesized through photogrammetry based on images captured by one or more cameras.

The output perspective representation of the scene generated by the perspective computer vision machine learning model 120 can be a perspective representation of any modality. For example, the output perspective representation can be a semantic segmentation mask of the input scene, an instance segmentation mask of the input scene, bounding boxes identifying locations and geometries of one or more objects detected in the input scene, or key points that mark features (e.g., a corner or a point on the outer boundary) of the objects detected in the input scene. The semantic segmentation mask associates every pixel of an image with a class label, e.g., as a vehicle, a pedestrian, or a road sign. The instance segmentation mask associates pixels of multiple objects of the same class as distinct individual instances, e.g., as a vehicle A, vehicle B, and so on.

The system 100 uses the perspective computer vision machine learning model 120 to process the first input data 112 to generate the first perspective representation 132. The first input data 112 characterizes a scene in the environment from a first viewpoint. The first perspective representation 132 is a perspective representation of the scene from the first viewpoint.

In an example, the first data can include an image of the scene captured by an imaging device (e.g., a camera) at the first viewpoint. In another example, the first data can include point cloud data of the scene captured at the first viewpoint.

The first perspective representation 132 can be a perspective representation of any modality. For example, the first perspective representation 132 can be a semantic segmentation mask of the scene from the first viewpoint, an instance segmentation mask of the scene from the first viewpoint, bounding boxes identifying locations and geometries of one or more objects detected in the scene from the first viewpoint, or key points that mark features (e.g., a corner or a point on the outer boundary) of the objects detected in the scene from the first viewpoint.

The system 100 further uses the perspective computer vision machine learning model 120 to process the second input data 114 to generate the second perspective representation 134. The second input data 114 characterizes a scene in the environment from a second viewpoint. The second perspective representation 134 is a perspective representation of the scene from the second viewpoint.

The second view point is different from the first view point. For example, the first and the second viewpoints can have different spatial locations. That is, the first viewpoint is at a first spatial location in the environment and the second viewpoint is at a second, different spatial location in the environment. In another example, the first and the second viewpoints can be at different time points. That is, the first viewpoint is at a first time point and the second viewpoint is at a different, second time point. In another example, the first and the second viewpoints can be at both different spatial locations and different time points.

In one example, the first and second data can be generated by sensors of an autonomous vehicle, e.g., a land, air, or sea vehicle. The sensors make measurements of a scene that is in the vicinity of the autonomous vehicle. The first data can be data generated of the scene at a first time point when the autonomous vehicle is at a first spatial location. The second data can be data generated of the scene at a later time point when the autonomous vehicle moves to a second spatial location.

Similar to the first data, the second data can include an image of the scene captured by an imaging device (e.g., a camera) at the second viewpoint. In another example, the second data can include point cloud data of the scene captured at the first viewpoint.

Similar to the first perspective representation 132, the second perspective representation 134 can be a perspective representation of any modality. For example, the second perspective representation 134 can be a semantic segmentation mask of the scene from the second viewpoint, an instance segmentation mask of the scene from the second viewpoint, bounding boxes identifying locations and geometries of one or more objects detected in the scene from the second viewpoint, or key points that mark features (e.g., a corner or a point on the outer boundary) of the objects detected in the scene from the second viewpoint.

The system 100 can process the first perspective representation 132 together with viewpoint information 136 using a view synthesis system 140 to generate a predicted second perspective representation 144. The predicted second perspective representation is a predicted representation of the scene from the second viewpoint that is predicted based on the first perspective representation of the scene from the first viewpoint.

The viewpoint information 136 characterizes the first and/or the second viewpoints. Concretely, the viewpoint information 136 includes one or more of (i) data characterizing the first viewpoint, (ii) data characterizing the second viewpoint, or (iii) data characterizing a difference between the first viewpoint and the second viewpoint.

In an example, the viewpoint information 136 can include depth information for the first viewpoint, the second viewpoint, or both. The depth information for a specific viewpoint can include distances from the viewpoint to one or more objects in the scene. The depth information can be obtained from various sources, such as from an image-based depth prediction model, a LiDAR scan or other 3D sensors.

In another example, the viewpoint information 136 can include pose information describing a location of the first viewpoint, the second viewpoint, or both. The pose information can further include orientation (or attitude) information of one or more sensors at the viewpoint when generating measurement data of the scene. The viewpoint pose information can be obtained from various sources, e.g., from a positioning sensor, from position prediction based on odometry data, or from position predictions based on other sensor data, such as GPS data, speedometer data, IMU data, and LiDAR alignment data.

In another example, the viewpoint information 136 can include dynamics information characterizing motion of non-static parts of the scene between the first viewpoint and the second viewpoint. The dynamics information can include, for example, the linear speed, the linear acceleration, the angular speed, the angular acceleration, and directions of the motions of one or more objects in the scene. The dynamics information can be obtained based on sensor measurements of motion and positioning sensors. The dynamics information can also be obtained from predictions based on images. For example, a per-instance motion predictor (in the form of per-object rigid motion or per-object 3D flow), or a global dynamic motion predictor (in the form of global 3D flow) can be used to predict the dynamics information.

In another example, the viewpoint information 136 can include data specifying a time difference between the first viewpoint and the second viewpoint. For example, the first data characterizing the scene at the first viewpoint can be generated by an autonomous vehicle at a first time point. The second data characterizing the scene at the second viewpoint can be generated by the autonomous vehicle at a second time point. The input to the view synthesis system can include a difference between the first time point and the second time point.

The view synthesis system 140 can be a model that is independent of the perspective computer vision machine learning model. In some implementations, the view synthesis model can be a machine learning model that has been pre-trained, e.g., a regression model or a neural network model that has been pre-trained. In one example, the perspective representation in the input of the view synthesis system 140 is generated based on image frames captured by a camera, and accurate intrinsic calibration of the camera is not available. In this scenario, the view synthesis system 140 can include a machine learning model with learnable parameters for characterizing the intrinsic matrix of the camera. In some other implementations, the view synthesis model can be a fixed model that does not contain any learnable components. In one example, data for the depth estimates, camera calibration and positioning are available. The fixed model can be a geometric projection model that generates warped pixel-wise outputs based on the known parameters.

The predicted second perspective representation 144 outputted by the view synthesis system 140 can have the same modality as first representation 132 in the input to the view synthesis system 140. For example, the first representation 132 and the predicted second perspective representation 144 can be semantic segmentation masks of the scene from the first and second viewpoints, respectively. In another example, the first representation 132 and the predicted second perspective representation 144 can be instance segmentation masks of the scene from the first and second viewpoints, respectively. In another example, the first representation 132 and the predicted second perspective representation 144 can include bounding boxes identifying locations and geometries of one or more objects detected in the scene from the first and second viewpoints, respectively. In another example, the first representation 132 and the predicted second perspective representation 144 can include key points that mark features (e.g., a corner or a point on the outer boundary) of the objects detected in the scene from the first and second viewpoints, respectively.

The system 100 determines a consistency error 150 between the second perspective representation 134 outputted by the perspective computer vision machine learning model 130 and the predicted second perspective representation 144 outputted by the view synthesis system 140. For example, the system 100 can compute an L2 distance between the second perspective representation 134 and the predicted second perspective representation 144. In another example, system 100 can formulate the consistency error 150 as a contrastive loss, and perform the training process based on positive and negative pairs.

The system 100 includes a parameter update engine 160 that updates the model parameters 125 of the perspective computer vision machine learning model 120 based on the determined consistency error 150. For example, the perspective computer vision machine learning model 150 can be a neural network. The parameter update engine 160 can compute gradients of the consistency error 150 with respect to the model parameters (e.g., weight and bias coefficients) of the neural network, and use the computed gradients to update the model parameters of the perspective computer vision neural network using any optimizer for neural network training, e.g., SGD, Adam, or rmsProp.

In some implementations, the operations performed by the view synthesis system 140 to generate the predicted perspective representation are differentiable. The parameter update engine 160 can evaluate the gradients of the consistency error with respect to the model parameters of the perspective computer vision machine learning model 120 at the first perspective representation 132 by backpropagating the gradients through the view synthesis system 140. The parameter update engine 160 can compute two updates of model parameters. For the first update, the parameter update engine 160 can backpropagate the gradients through the view synthesis system 140 to the first perspective representation 132 to update the model parameters of the view synthesis system 140. For the second update, the parameter update engine 160 can backpropagate the gradients through the perspective computer vision machine learning model 120 to update the model parameters of the perspective computer vision machine learning model 120.

Alternatively, the parameter update engine 160 can evaluate the gradients of the consistency error with respect to the model parameters of the perspective computer vision machine learning model 120 at the second perspective representation 134 without needing to backpropagate gradients through the view synthesis system 140.

In some other implementations, the operations performed by the view synthesis system 140 to generate the predicted perspective representation are not differentiable. In this scenario, the parameter update engine 160 can evaluate the gradients of the consistency error with respect to the model parameters of the perspective computer vision machine learning model 120 at the second perspective representation 134 without needing to backpropagate gradients through the view synthesis system.

The system 100 can repeat the above process for different sets of the first and second input data to repeatedly update the model parameters 125 of the perspective computer vision machine learning model 120. For each set of the first and second input data, the system 100 can further perform the parameter updates by reversing the uses of the first and the second input data. That is, the system can process the second perspective representation 134 of the scene and the viewpoint information 136 using the view synthesis system to generate, as output from the input, a predicted first perspective representation of the scene from the first view point, determine the consistency error between the first perspective representation and the predicted first perspective representation, and determine, from the consistency error, an update to the current values of the model parameters 125. In some implementations, the system 100 updates the model parameters 125 based on the consistency error for a batch of multiple first input/second input pairs.

By performing the above process, the system 100 can train the perspective computer vision machine learning model 120 based on the consistency constraints computed from unlabeled data, since the first input data 112 and second input data 114 do not contain labels for the perspective computer vision machine learning model 120.

In this specification, “labeled data” refers to data that includes an output for a particular task, where “unlabeled data” refers to data that does not include an output for the particular task.

In addition to this unsupervised training of the perspective computer vision machine learning model 120, the system 100 can further perform supervised training of the perspective computer vision machine learning model 120 on labeled data. The labeled data can include one or more training examples. Each training example includes a training input that characterizes a scene from a view point and a training label that annotates the training input with the corresponding perspective representation of the scene from the view point. The system 100 can update the model parameters 125 of the perspective computer vision machine learning model 120 by minimizing a supervised loss based on the labeled data. By combining the supervised training using labeled data (e.g., a small amount of available labeled data) and the unsupervised training using unlabeled data (e.g., a large amount of available unlabeled data), the system 100 can produce model parameters for the perspective computer vision machine learning model with better quality using limited labeled data.

In some implementations, the system 100 can implement the supervised training jointly with the unsupervised training. That is, the system can update the model parameters 125 based on a loss including both a supervised loss term and an unsupervised term (i.e., the consistency loss). In some other implementations, they system 100 can sequentially implement the supervised training and the unsupervised training. That is, the system 100 can perform the supervised training first, followed by the unsupervised training, or vice versa.

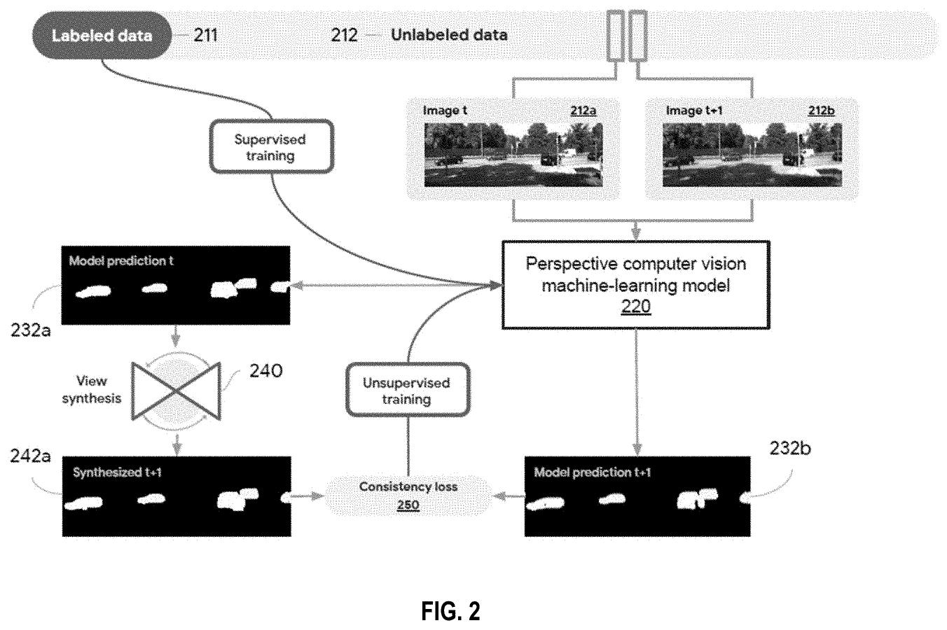

FIG. 2 illustrates the data flow of an example process of training a perspective computer vision machine learning model 220. For convenience, the process will be described as being performed by a system of one or more computers located in one or more locations. For example, a machine learning model training system, e.g., the machine learning model training system 100 of FIG. 1, appropriately programmed in accordance with this specification, can perform the process to train a perspective computer vision machine learning model.

The training data can include a limited amount of labeled data 211 and a greater amount of unlabeled data 212. The unlabeled data 212 can include a sequence of images of a scene captured by an image sensor of an autonomous vehicle at different time points.

The system uses the perspective computer vision machine learning model 220 to process a first image 212a captured at a first time point t to generate a model prediction 232a. The perspective computer vision machine learning model 220 is a semantic segmentation model. The model prediction 232a is a semantic segmentation mask that segments images of other vehicles in the scene at time point t.

The system further uses the perspective computer vision machine learning model 220 to process a second image 212b in the unlabeled data 212 captured at a second time point t+1 to generate a second model prediction 232b. The second model prediction 232b is a semantic segmentation mask that segments images of other vehicles in the scene at time point t+1.

The system uses the view synthesis system 240 to process the model prediction 232a to generate a synthesized image 242a. The synthesized image 242a is a predicted version of the segmentation mask that segments images of other vehicles in the scene at time point t+1.

The system computes the consistency loss 250 based on the synthesized image 242a and the second model prediction 232b, and uses the consistency loss 250 to update the model parameters of the perspective computer vision machine learning model 220. The system can repeat the above unsupervised training process using different pairs of images from the unlabeled training data 212.

The labeled data 211 can include one or more training examples. Each training example includes a training input and a training label. The training input includes an image of a scene, and the training label includes a semantic segmentation mask of the image in the training input. The system can further perform a supervised training of the perspective computer vision machine learning model 220 on the labeled data 211.

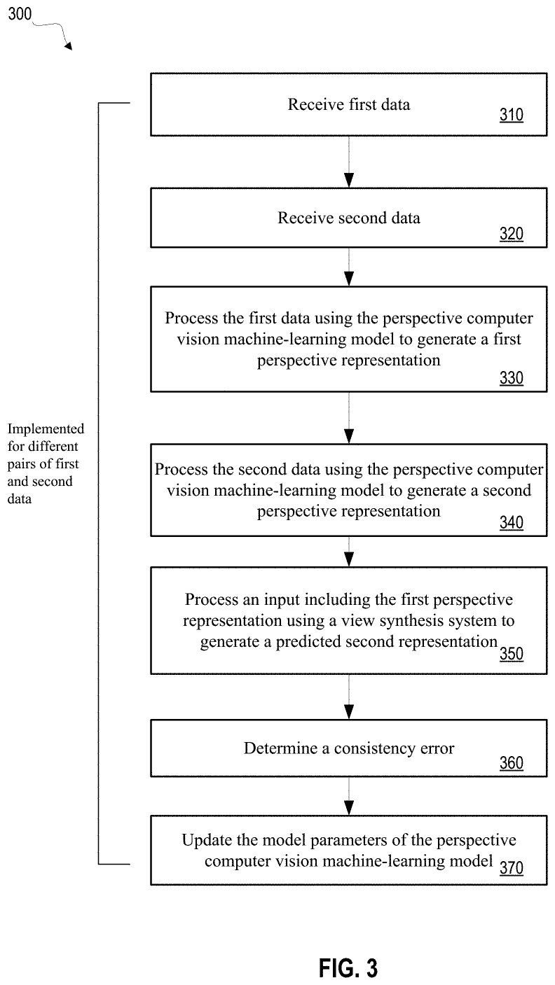

FIG. 3 is a flow diagram illustrating an example process 300 for training a perspective computer vision machine learning model. For convenience, the process 300 will be described as being performed by a system of one or more computers located in one or more locations. For example, a machine learning model training system, e.g., the machine learning model training system 100 of FIG. 1, appropriately programmed in accordance with this specification, can perform the process 300 to train the perspective computer vision machine learning model.

The perspective computer vision machine learning model has a plurality of model parameters, and is configured to receive input data characterizing an input scene in an environment from an input viewpoint and to process the input data in accordance with the model parameters to generate an output perspective representation of the scene from the input viewpoint.

In some implementations, the perspective computer vision machine learning model can be a neural network having any appropriate neural network architecture that allows the model to map the input data to the perspective representation. For example, the neural network can include a convolutional neural network. The model parameters include network parameters (e.g., the weight and bias coefficients) of the neural network.

The perspective computer vision machine learning model can be a variety of computer-vision related prediction models. For example, the perspective computer vision machine learning model can be a semantic segmentation model that outputs a semantic segmentation mask of the input scene at the input viewpoint. In another example, the perspective computer vision machine learning model can be an object detection model that outputs data identifying locations of one or more objects in the input scene at the input viewpoint. In another example, the perspective computer vision machine learning model can be an instance segmentation model that outputs an instance segmentation mask of the input scene at the input viewpoint.

The input data characterizing the scene can be generated, for example, from sensor readings of the scene captured by one or more sensors at the corresponding viewpoint. The one or more sensors are sensors of an autonomous vehicle.

The input data characterizing the scene can include various types of data. In an example, the input data can include an image of the environment captured by an imaging device (e.g., a camera) at an input viewpoint. In another example, the input data can include point cloud data of the environment captured at the input viewpoint. The point cloud data can be generated based on measurements made by a scanning device (e.g., a LiDAR device) at the input viewpoint. The point cloud data can also be synthesized through photogrammetry based on images captured by one or more cameras.

The output perspective representation of the scene generated by the perspective computer vision machine learning model can be a perspective representation of any modality. For example, the output perspective representation can be a semantic segmentation mask of the input scene, an instance segmentation mask of the input scene, bounding boxes identifying locations and geometries of one or more objects detected in the input scene, or key points that mark features (e.g., a corner or a point on the outer boundary) of the objects detected in the input scene.

In step 310, the system receives first data. The first data will be used as input data to the perspective computer vision machine learning model to generate a first perspective representation, and characterizes a scene in the environment from a first viewpoint.

In an example, the first data can include an image of the scene captured by an imaging device (e.g., a camera) at the first viewpoint. In another example, the first data can include point cloud data of the scene captured at the first viewpoint.

In step 320, the system receives second data. The second data will be used as input data to the perspective computer vision machine learning model to generate a second perspective representation, and characterizes a scene in the environment from a second viewpoint.

The second view point is different from the first view point. For example, the first and the second viewpoints can have different spatial locations. That is, the first viewpoint is at a first spatial location in the environment and the second viewpoint is at a second, different spatial location in the environment. The first and the second viewpoints can also be at different time points. That is, the first viewpoint is at a first time point and the second viewpoint is at a different, second time point.

In one example, the first and second data can be generated by sensors of an autonomous vehicle, e.g., a land, air, or sea vehicle. The sensors make measurements of a scene that is in the vicinity of the autonomous vehicle. The first data can be data generated of the scene at a first time point when the autonomous vehicle is at a first spatial location. The second data can be data generated of the scene at a later time point when the autonomous vehicle moves to a second spatial location.

Similar to the first data, the second data can include an image of the scene captured by an imaging device (e.g., a camera) at the second viewpoint. In another example, the second data can include point cloud data of the scene captured at the first viewpoint.

In step 330, the system processes the first data using the perspective computer vision machine-learning model to generate a first perspective representation. For example, the perspective computer vision machine learning model can be a neural network, e.g., a convolutional neural network. The system can generate a neural network input based on the first data and process the neural network input using the perspective computer vision neural network with the current values of the model parameters (e.g., the weight and bias coefficients of the neural network) to generate the first perspective representation of the scene from the first viewpoint.

The first perspective representation of the scene generated by the perspective computer vision machine learning model can be a perspective representation of any modality. For example, the first perspective representation can be a semantic segmentation mask of the scene from the first viewpoint, an instance segmentation mask of the scene from the first viewpoint, bounding boxes identifying locations and geometries of one or more objects detected in the scene from the first viewpoint, or key points that mark features (e.g., a corner or a point on the outer boundary) of the objects detected in the scene from the first viewpoint.

In step 340, the system processes the second data using the computer vision machine-learning model to generate a second perspective representation. For example, the system can generate a neural network input based on the second data and process the neural network input using the perspective computer vision neural network with the current values of the model parameters (e.g., the weight and bias coefficients of the neural network) to generate the second perspective representation of the scene from the second viewpoint.

Similar to the first perspective representation generated in step 330, the second perspective representation of the scene generated by the perspective computer vision machine learning model can be a perspective representation of any modality. For example, the second perspective representation can be a semantic segmentation mask of the scene from the second viewpoint, an instance segmentation mask of the scene from the second viewpoint, bounding boxes identifying locations and geometries of one or more objects detected in the scene from the second viewpoint, or key points that mark features (e.g., a corner or a point on the outer boundary) of the objects detected in the scene from the second viewpoint.

In step 350, the system processes an input including the first perspective representation using a view synthesis system to generate a predicted second perspective representation. The predicted second perspective representation is a predicted representation of the scene from the second viewpoint that is predicted based on the first perspective representation of the scene from the first viewpoint.

In addition to the first perspective representation generated by step 310, the input to the view synthesis system can include additional information characterizing the first and/or the second viewpoints. Concretely, the input to the view synthesis system can further include one or more of (i) data characterizing the first viewpoint, (ii) data characterizing the second viewpoint, or (iii) data characterizing a difference between the first viewpoint and the second viewpoint.

In an example of the additional information, the input to the view synthesis system can include depth information for the first viewpoint, the second viewpoint, or both. The depth information for a specific viewpoint can include distances from the viewpoint to one or more objects in the scene. The depth information can be obtained from various sources, such as from an image-based depth prediction model, a LiDAR scan or other 3D sensors.

In another example of the additional information, the input to the view synthesis system can include pose information describing a location of the first viewpoint, the second viewpoint, or both. The pose information can further include orientation (or attitude) information of one or more sensors at the viewpoint when generating measurement data of the scene. The viewpoint pose information can be obtained from various sources, e.g., from a positioning sensor, from position prediction based on odometry data, or from position predictions based on other sensor data, such as GPS data, speedometer data, IMU data, and LiDAR alignment data).

In another example of the additional information, the input to the view synthesis system can include dynamics information characterizing motion of non-static parts of the scene between the first viewpoint and the second viewpoint. The dynamics information can include, for example, the linear speed, the linear acceleration, the angular speed, the angular acceleration, and directions of the motions of one or more objects in the scene. The dynamics information can be obtained based on sensor measurements of motion and positioning sensors. The dynamics information can also be obtained from predictions based on images. For example, a per-instance motion predictor (in the form of per-object rigid motion or per-object 3D flow), or a global dynamic motion predictor (in the form of global 3D flow) can be used to predict the dynamics information.

In another example of the additional information, the input to the view synthesis system can include data specifying a time difference between the first viewpoint and the second viewpoint. For example, the first data characterizing the scene at the first viewpoint can be generated by an autonomous vehicle at a first time point. The second data characterizing the scene at the second viewpoint can be generated by the autonomous vehicle at a second time point. The input to the view synthesis system can include a difference between the first time point and the second time point.

The view synthesis system can be a model that is independent of the perspective computer vision machine learning model. In some implementations, the view synthesis model can be a machine learning model that has been pre-trained, e.g., a regression model or a neural network model that has been pre-trained. In some other implementations, the view synthesis model can be a fixed model that does not contain any learnable components.

The predicted second perspective representation outputted by the view synthesis system can have the same modality as the first representation in the input to the view synthesis system. For example, the first representation and the predicted second perspective representation can be semantic segmentation masks of the scene from the first and second viewpoints, respectively. In another example, the first representation and the predicted second perspective representation can be instance segmentation masks of the scene from the first and second viewpoints, respectively. In another example, the first representation and the predicted second perspective representation can include bounding boxes identifying locations and geometries of one or more objects detected in the scene from the first and second viewpoints, respectively. In another example, the first representation and the predicted second perspective representation can include key points that mark features (e.g., a corner or a point on the outer boundary) of the objects detected in the scene from the first and second viewpoints, respectively.

In step 360, the system determines a consistency error. Concretely, the system determines a consistency error between the second perspective representation outputted by the perspective computer vision machine learning model and the predicted second perspective representation outputted by the view synthesis system. For example, the system can compute an L2 distance between the second perspective representation outputted by the perspective computer vision machine learning model and the predicted second perspective representation outputted by the view synthesis system.

In step 370, the system updates the model parameters of the perspective computer vision machine learning model based on the determined consistency error. For example, the perspective computer vision machine learning model is a neural network. The system can compute gradients of the consistency error with respect to the model parameters of the neural network, and use the computed gradients to update the model parameters (e.g., weight and bias coefficients) of the perspective computer vision neural network using any optimizer for neural network training, e.g., SGD, Adam, or rmsProp.

In some implementations, the operations performed by the view synthesis system to generate the predicted perspective representation are differentiable. The system can evaluate the gradients of the consistency error with respect to the model parameters of the perspective computer vision machine learning model at the first perspective representation by backpropagating through the view synthesis system. Alternatively, the system can evaluate the gradients of the consistency error with respect to the model parameters of the perspective computer vision machine learning model at the second perspective representation without needing to backpropagate gradients through the view synthesis system.

In some other implementations, the operations performed by the view synthesis system to generate the predicted perspective representation are not differentiable. In this scenario, the system can evaluate the gradients of the consistency error with respect to the model parameters of the perspective computer vision machine learning model at the second perspective representation without needing to backpropagate gradients through the view synthesis system.

The system can repeat steps 310-370 for different sets of the first and second data to repeatedly update the model parameters of the perspective computer vision machine learning model. For each set of the first and second data, the system can further perform the parameter updates by reversing the uses of the first and the second data. That is, after performing steps 310 and 320, the system can process an input including the second perspective representation of the scene using the view synthesis system to generate, as output from the input, a predicted first perspective representation of the scene from the first view point, determine the consistency error between the first perspective representation and the predicted first perspective representation, and determine, from the consistency error, a second update to the current values of the model parameters. In some implementations, the system updates the model parameters based on the consistency error for a batch of multiple first input/second input pairs.

By repeatedly performing steps 310-370, the system can perform training of the perspective computer vision machine learning model based on the consistency constraints computed from unlabeled data, since the first data and second data do not contain labels for the perspective computer vision machine learning model.

In addition to this unsupervised training of the perspective computer vision machine learning model, the system can further perform supervised training of the perspective computer vision machine learning model on labeled data. The labeled data can include one or more training examples. Each training example includes a training input that characterizes a scene from a view point and a training label that annotates the training input with the corresponding perspective representation of the scene from the view point. The system can update the model parameters of the perspective computer vision machine learning model by minimizing a supervised loss based on the labeled data.

In some implementations, the system can implement the supervised training jointly with the unsupervised training. That is, the system can update the model parameters based on a loss including both a supervised loss term and an unsupervised term (i.e., the consistency loss). In some other implementations, they system can sequentially implement the supervised training and the unsupervised training. That is, the system can perform the supervised training first, followed by the unsupervised training, or vice versa.

By combining the supervised training using labeled data (e.g., a small amount of available labeled data) and the unsupervised training using unlabeled data (e.g., a large amount of available unlabeled data), the system can produce model parameters for the perspective computer vision machine learning model with better quality using limited labeled data.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of training a perspective computer vision machine learning model having a plurality of model parameters and configured to receive input data characterizing an input scene in an environment from an input viewpoint and to process the input data in accordance with the model parameters to generate an output perspective representation of the scene from the input viewpoint, the method comprising:
receiving first data characterizing a scene in the environment from a first viewpoint;
receiving second data characterizing the scene in the environment from a second, different viewpoint;
processing the first data using the perspective computer vision machine learning model in accordance with current values of the model parameters to generate a first perspective representation of the scene from the first viewpoint;
processing the second data using the perspective computer vision machine learning model in accordance with the current values of the model parameters to generate a second perspective representation of the scene from the second viewpoint;
processing a first input comprising the first perspective representation of the scene using a view synthesis system that generates, as output from the first input, a predicted perspective representation of the scene from the second view point;
determining a first consistency error between the (i) second perspective representation and (ii) the predicted perspective representation; and
determining, from the first consistency error, an update to the current values of the model parameters.

2. The method of claim 1, wherein the operations performed by the view synthesis system to generate the predicted perspective representation are differentiable and wherein determining, from the first consistency error, an update to the current values of the model parameters comprises:
determining a first gradient of the first consistency error with respect to the model parameters and evaluated at the first perspective representation by backpropagating through the view synthesis system.

3. The method of claim 1, wherein determining, from the first consistency error, an update to the current values of the model parameters comprises:
determining a second gradient of the first consistency error with respect to the model parameters and evaluated at the second perspective representation.

4. The method of claim 3, wherein the operations performed by the view synthesis system to generate the predicted perspective representation are not differentiable.

5. The method of claim 1, further comprising:
processing a second input comprising the second perspective representation of the scene using the view synthesis system to generate, as output from the second input, a first predicted perspective representation of the scene from the first view point;
determining a second consistency error between the (i) first perspective representation and (ii) the first predicted perspective representation; and
determining, from the second consistency error, a second update to the current values of the model parameters.

6. The method of claim 1, wherein the perspective computer vision machine learning model is a semantic segmentation model and the output perspective representation is a semantic segmentation mask of the input scene at the input viewpoint.

7. The method of claim 1, wherein the perspective computer vision machine learning model is an object detection model and the output perspective representation identifies locations of one or more objects in the input scene at the input viewpoint.

8. The method of claim 1, wherein the perspective computer vision machine learning model is an instance segmentation model and the output perspective representation is an instance segmentation mask of the input scene at the input viewpoint.

9. The method of claim 1, wherein the input data characterizing the input scene includes an image of the environment captured at the input viewpoint.

10. The method of claim 1, wherein the input data characterizing the input scene includes point cloud data of the environment captured at the input viewpoint.

11. The method of claim 1, wherein the input data characterizing the input scene includes data generated from sensor readings of one or more sensors at the input viewpoint.

12. The method of claim 11, wherein the one or more sensors are sensors of an autonomous vehicle.

13. The method of claim 1, wherein the first viewpoint is at a first time and the second viewpoint is at a different, second time.

14. The method of claim 1, wherein the first viewpoint is at a first spatial location in the environment and the second viewpoint is at a second, different spatial location in the environment.

15. The method of claim 1, wherein the first input further comprises one or more of (i) data characterizing the first viewpoint, (ii) data characterizing the second viewpoint, or (iii) data characterizing a difference between the first viewpoint and the second viewpoint.

16. The method of claim 1, further comprising:
training the perspective computer vision model on labeled data to minimize a supervised loss.

17. A system comprising one or more computers and one or more storage devices storing instructions that are operable, when executed by the one or more computers, to cause the one or more computers to train a perspective computer vision machine learning model having a plurality of model parameters and configured to receive input data characterizing an input scene in an environment from an input viewpoint and to process the input data in accordance with the model parameters to generate an output perspective representation of the scene from the input viewpoint, the training comprising:
receiving first data characterizing a scene in the environment from a first viewpoint;
receiving second data characterizing the scene in the environment from a second, different viewpoint;
processing the first data using the perspective computer vision machine learning model in accordance with current values of the model parameters to generate a first perspective representation of the scene from the first viewpoint;
processing the second data using the perspective computer vision machine learning model in accordance with the current values of the model parameters to generate a second perspective representation of the scene from the second viewpoint;
processing a first input comprising the first perspective representation of the scene using a view synthesis system that generates, as output from the first input, a predicted perspective representation of the scene from the second view point;
determining a first consistency error between the (i) second perspective representation and (ii) the predicted perspective representation; and
determining, from the first consistency error, an update to the current values of the model parameters.

18. The system of claim 17, wherein the perspective computer vision machine learning model is a semantic segmentation model and the output perspective representation is a semantic segmentation mask of the input scene at the input viewpoint.

19. A computer storage medium encoded with instructions that, when executed by one or more computers, cause the one or more computers to train a perspective computer vision machine learning model having a plurality of model parameters and configured to receive input data characterizing an input scene in an environment from an input viewpoint and to process the input data in accordance with the model parameters to generate an output perspective representation of the scene from the input viewpoint, the training comprising:
receiving first data characterizing a scene in the environment from a first viewpoint;
receiving second data characterizing the scene in the environment from a second, different viewpoint;
processing the first data using the perspective computer vision machine learning model in accordance with current values of the model parameters to generate a first perspective representation of the scene from the first viewpoint;
processing the second data using the perspective computer vision machine learning model in accordance with the current values of the model parameters to generate a second perspective representation of the scene from the second viewpoint;
processing a first input comprising the first perspective representation of the scene using a view synthesis system that generates, as output from the first input, a predicted perspective representation of the scene from the second view point;
determining a first consistency error between the (i) second perspective representation and (ii) the predicted perspective representation; and
determining, from the first consistency error, an update to the current values of the model parameters.

20. The computer storage medium of claim 19, wherein the perspective computer vision machine learning model is an object detection model and the output perspective representation identifies locations of one or more objects in the input scene at the input viewpoint.
